(19) United States
(12) Patent Application Publication
(10) Pub. No.: US 2026/0336783 A1
(43) Pub. Date: Oct. 29, 2026

(54) CARGO AIRCRAFT

(71) Applicant: Christopher Edgette, Menlo Park, CA (US)

(72) Inventor: Christopher Edgette, Menlo Park, CA (US)

(21) Appl. No.: 19/490,352

(22) PCT Filed: Jun. 6, 2024
(86) PCT No.: PCT/US2024/032883

§ 371 Date: Dec. 4, 2025

Related U.S. Application Data
(60) Provisional application No. 63/471,466, filed on Jun. 6, 2023.

(51) Int. Cl. B64C 1/22; B64C 1/30; B64C 25/58; B64C 29/02; B64D 27/40

(52) U.S. Cl. CPC B64C 1/22; B64C 1/30; B64C 25/58; B64C 29/02; B64D 27/402; B64C 2211/00

(57) ABSTRACT

An example of a rotating monowing aircraft with streamlined removable cargo pod is described. An example of an aircraft in shipping position is described. An example of a shipping optimized tail-sitter with variable orientation cargo pod is described. An example of a shipping optimized tail-sitter with variable orientation cargo pod lifting/dropping sequence is described.

### BACKGROUND

Aircraft are needed that are capable of rapid and autonomous cargo delivery, addressing the high demand from military and civilian applications.

### SUMMARY

An aircraft is designed to fit into confined spaces such as cargo planes or standard shipping containers, including those measuring approximately 7.5 feet×7.5 feet×20 feet internally. Multiple inventions related to this packaging technique focus on achieving good lift-to-drag ratio, safety characteristics, and minimizing assembly requirements for deployment.

### BRIEF DESCRIPTION OF THE DRAWINGS

FIGS. 1A-1D depict an example of a rotating monowing architecture with streamlined removable cargo pod in flight configuration. FIGS. 1A, 1B, 1C, and 1D are, respectively, front, top, isometric (ISO), and right-side views.

FIGS. 2A-2B depict an example of a rotating monowing architecture with streamlined removable cargo pod in takeoff configuration. FIGS. 2A and 2B are right ISO and right-side views.

FIGS. 3A-3G depict an example of a rotating monowing architecture with streamlined removable cargo pod in shipping position. FIGS. 3A, 3B, 3C, 3D, 3E, 3F, and 3G are, respectively, right ISO with shipping container outlines on center section, right-side (assembled) with shipping container outlines on center section, right-side showing 3 separate components, right-side showing shipping carrier, right-side showing shipping carrier in extended position, left-side detail of rotating landing skid in flight orientation, and left-side detail of rotating landing skid in landed orientation views.

FIG. 4 depicts an example of a rotating monowing architecture with streamlined removable cargo pod, top view.

FIG. 5 depicts an example of a rotating monowing architecture with movable pylons, stowed, 2 propeller diagram.

FIG. 6 depicts an example of a rotating monowing architecture with movable pylons, stowed, 3 propeller diagram.

FIG. 7 depicts an example of a rotating monowing architecture with movable pylons, assembled, 2 propeller diagram.

FIG. 8 depicts an example of a rotating monowing architecture with movable pylons, assembled, 3 propeller diagram.

FIG. 9 depicts an example of a rotating monowing architecture with removable monowing section, assembled, diagram.

FIG. 10 depicts an example of a rotating monowing architecture with removable wing portions, assembled, diagram.

FIG. 11 depicts an example of a shipping optimized tail-sitter with variable orientation cargo pod, ISO view.

FIG. 12 depicts an example of a shipping optimized tail-sitter with variable orientation cargo pod, front view.

FIG. 13 depicts an example of a shipping optimized tail-sitter with variable orientation cargo pod, ISO view.

FIGS. 14A-14C depict an example of a shipping optimized tail-sitter with variable orientation cargo pod lifting/dropping sequence, left-side view. FIGS. 14A, 14B, and 14C depict, respectively, variable orientation cargo pod stowed, variable orientation cargo pod at 45-degree angle, and variable orientation cargo pod on ground.

FIG. 15 depicts an example of a shipping optimized tail-sitter flying with wings open, ISO view.

FIG. 16 depicts an example of a shipping optimized tail-sitter flying with wings open, top view.

FIGS. 17A-17C depict an example of a cargo arm lifting tail sitter to flight position, left-side view. FIGS. 17A, 17B, and 17C depict, respectively, a hinged lifting arm at 15 degrees, a hinged lifting arm at 45 degrees, and a hinged lifting arm at 90 degrees, aircraft at flight position.

### DETAILED DESCRIPTION

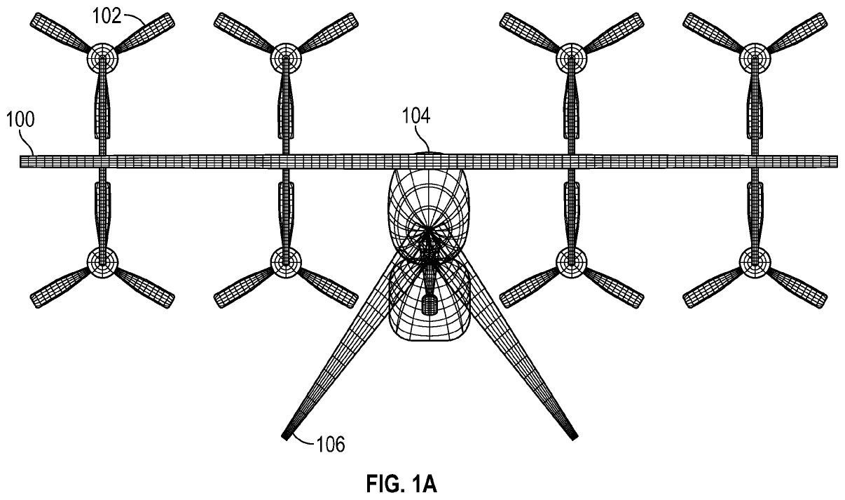

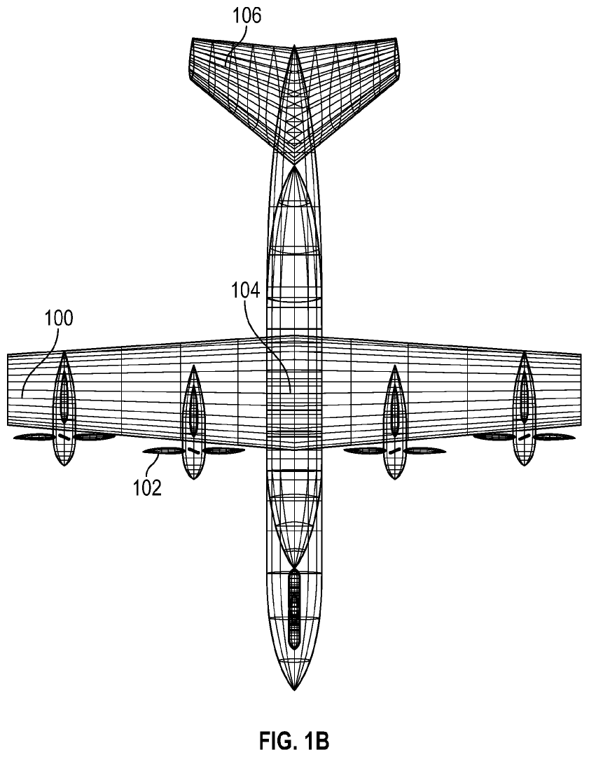

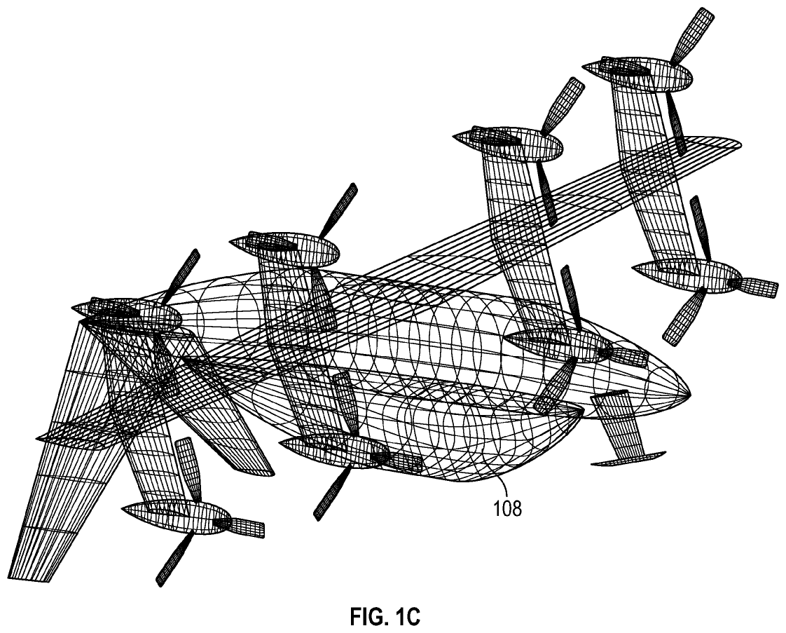

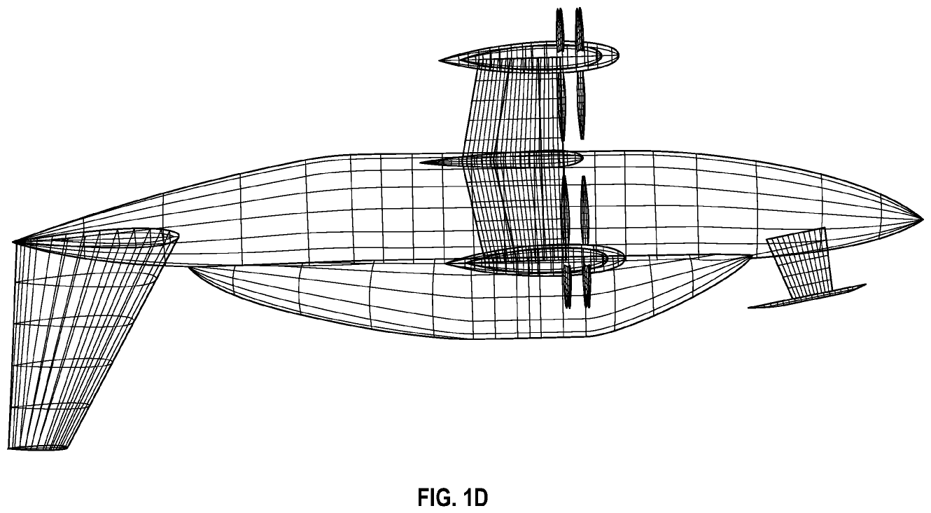

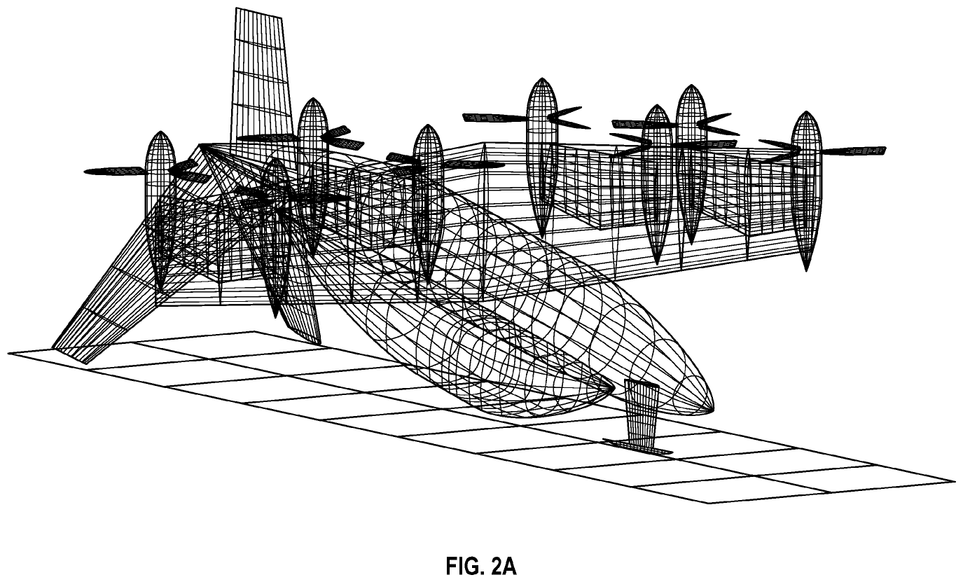

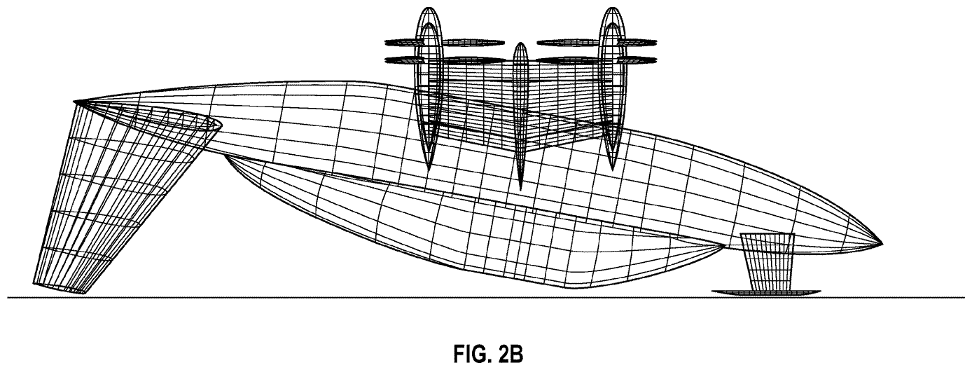

FIGS. 1A-1D and 2A-2B depict an example of an aircraft that employs a rotating monowing form factor, which offers maneuverability, redundancy, and simplicity. It comprises a single moving element that rotates all propulsors on the aircraft, transitioning from a hover and landing configuration to a flight configuration. Components illustrated in the example of FIGS. 1A-1D and 2A-2B include a rotating monowing 100, lift and cruise propulsors 102, angled fuselage 104, angled unified stabilizers and landing gear 106, and a streamlined removable cargo pod 108.

Lift and cruise propulsors allow the aircraft to take off vertically and cruise safely, efficiently, and quietly. In a specific implementation, lift and cruise propulsors include propellers. In alternatives, lift and cruise propulsors include ducted fans and/or other propulsion devices.

The angled fuselage is designed to be tilted relative to the ground upon landing. In a specific implementation, compact nose gear includes a retractable wheel. In alternatives, landing gear includes a skid and/or retractable element or a wheel that is not retractable. In the case of a skid, it may include the ability to re-orient itself in the direction of airflow during flight, and this capability can be combined with a shock absorption system of the nose landing gear.

In a specific implementation, wings go from vertical to horizontal position with a single pin through the fuselage. This can enable wing and propellers to tilt forward, but the fuselage stays level. It's nice if a passenger is lying down because of small aspect ratio (less drag). If you rock someone back from a sitting position, they end up in a narrow bubble, but they didn't have to get themselves there, so you don't have an uncomfortable entry/egress problem when getting them into the small aspect ratio. These issues are of lesser concern for cargo or pilots with appropriate training.

In cruising position, if a motor quits working, you can still land and crunch the tail section, even if stuck, which is generally true of any rotation point. The illustrated architecture provides more stroke than in landing position because stroke exposes some of fuselage in cruise position. In Vertical Take Off or Landing (VTOL), you can just drop onto stroke, even if stuck. Advantageously, in the event of an emergency landing, aircraft controls can take advantage of the increased stroke.

In VTOL, using the illustrated architecture, you have props blowing down on the fuselage. In a specific implementation, tilting the fuselage acts as a thrust redirector. Advantageously, leaning spars into wind ameliorates problems with cross winds (to separate fuselage from maneuver); the fuselage can also act as a control surface to control air flow and provide control to the vehicle.

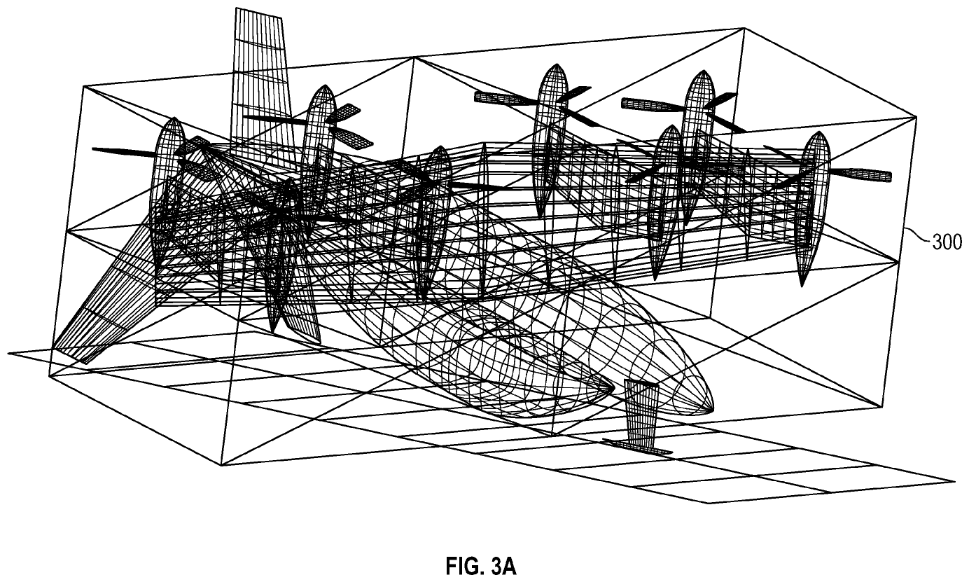

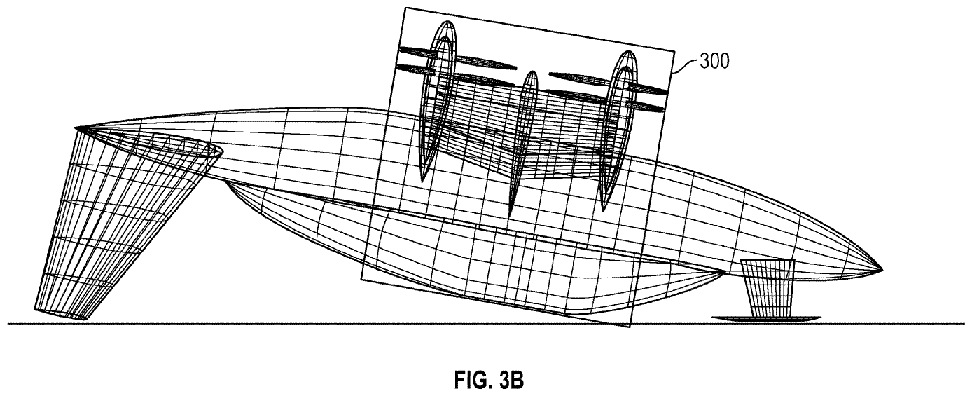

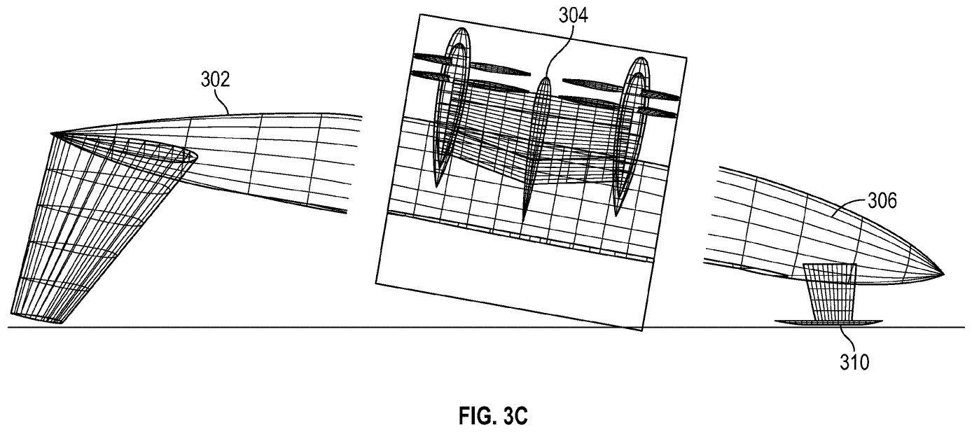

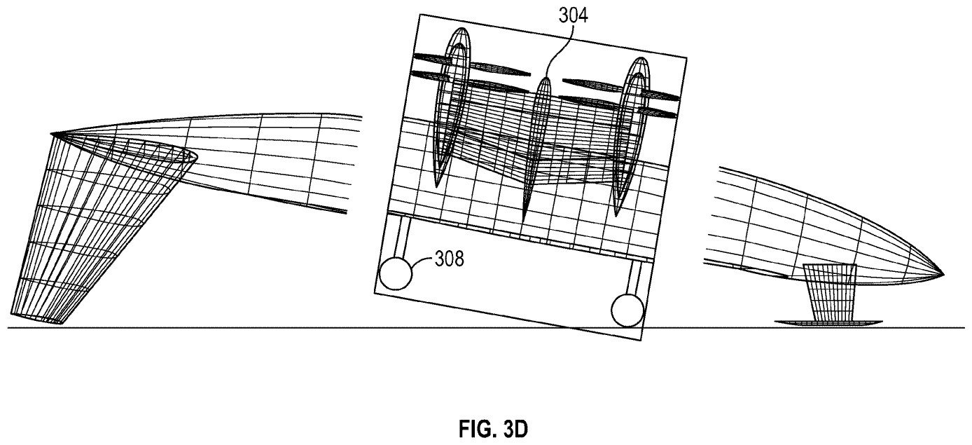

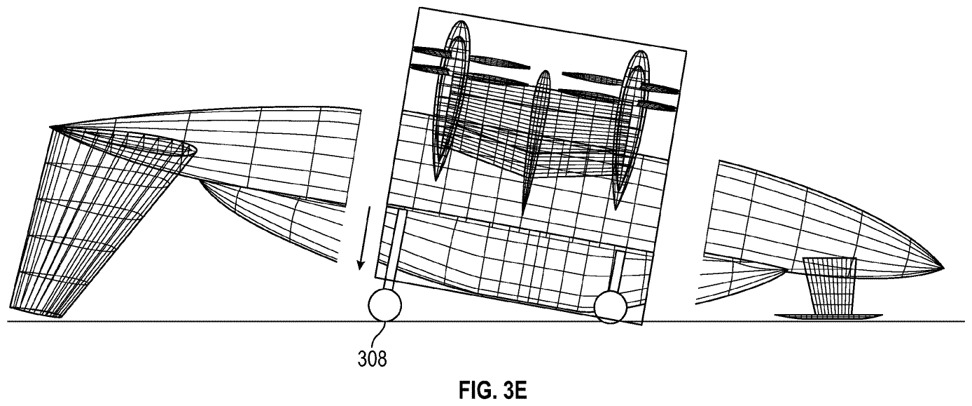

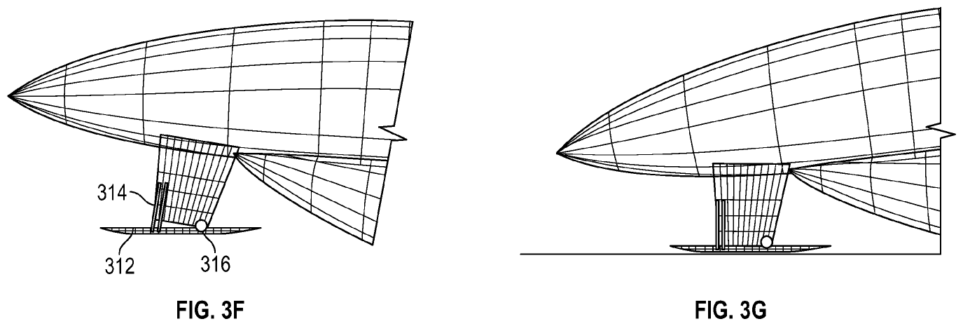

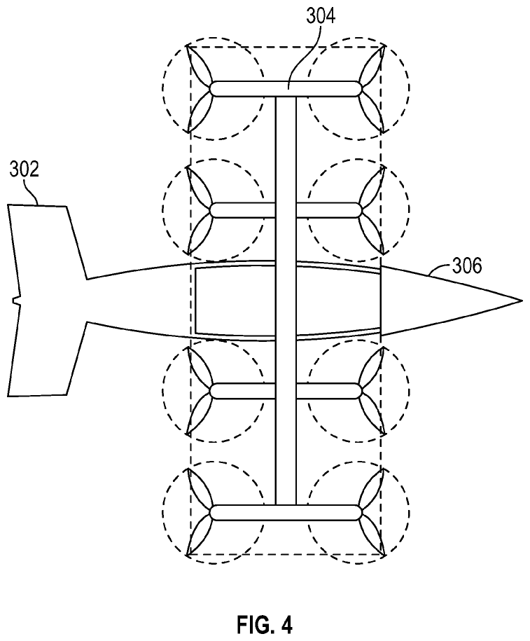

FIGS. 3A-3G and 4 depict an example of a rotating monowing architecture with streamlined removable cargo pod in shipping position. Components illustrated in the example of FIGS. 3A-3G and 4 include a modular tail section 302, a modular center section 304, a modular nose section 306, an angle and height adjustable shipping protrusion 308, compact nose gear(s) 310, a rotating landing skid 312, a landing skid shock absorber 314, and a landing skid pivot 316. FIGS. 3A-3G show how these components fit within a shipping container outline 300. In a specific implementation, the shipping container into which the aircraft fits when shipped is an intermodal freight container that is 8 feet (2.44 m) wide and 20 or 40 feet (6.10 or 12.19 m) long. Alternatives include but are not limited to high cube containers (providing an extra 1 ft (305 mm) in height to standard shipping containers), pallet wides, open tops, side loaders, double door or tunnel-tainers, and specialized containers.

The removable cargo pod includes bolts, screws, clamps, latches, straps, or other devices (not shown) for connecting the cargo pod to the aircraft. Some of the fastening apparatus may be permanently (as in, not intended to be removed during shipping and deployment of the aircraft) affixed to the aircraft, permanently affixed to the cargo pod, or removable from both the aircraft and the cargo pod when the cargo pod is detached from the aircraft. The desirability of lightweight components may result in implementations that include lightweight destructible components, as well, such as single-use adhesives, polymers, or the like. The ease with which a cargo pod can be affixed to the aircraft and removed therefrom is configuration-specific.

FIGS. 3A-3G show how the architecture involves packaging the full-length wing, pylons, motors, and lift and cruise propulsors together with the center section of the aircraft fuselage. The modular center section of the angled fuselage may accommodate several heavy and complex components that are best located at the center of gravity of the aircraft, including batteries, fuel systems, and connections to the cargo container. The modular nose section and modular tail sections may house sensors, powertrain components, landing gear, aerodynamic elements, or other applicable components. These modular sections can be added to the center section after unpacking the aircraft from the shipping container. The modularity of these sections allows them to be shipped in the same container as the center section or separately. The modular architecture also enhances the maintainability of the aircraft, providing easy access to for components requiring regular maintenance such as powertrain or sensors. Modular sections may also be swapped without repairing the components inside the module, increasing field serviceability and aircraft uptime.

Batteries, rotors, and props are the heaviest elements of the vehicle. In a specific implementation, most electronics and power train elements (including motor, power train wiring (usually high voltage, but not always), battery, etc.) are in the wing when the aircraft is deployed. The fuselage includes a cabin and fuselage wiring to power air conditioning, etc. Advantageously, wiring is short because battery, wing, rotor, and power train are all on the same element. There can be multiple movable subelements (e.g., rudders) on the wing, power train element, fuselage, or empennage. In an alternative, when deployed, most electronics and/or power train elements (e.g., batteries) are not in the wing. Bushings can provide additional isolation for a cabin; it is also possible to fly without a cabin.

FIGS. 3A-3G show each section of the aircraft may include an angle and height adjustable shipping protrusion. In an alternative, the adjustable shipping protrusion is height, but not angle, adjustable. The angle and height adjustable shipping protrusion facilitates proper orientation during shipping and can also be shifted to an angled assembly position on the ground, simplifying the assembly process. The angle and height adjustable shipping protrusion can include one or more rods, blocks, inflatable bags, or other rigid or flexible structures that can be extended from a first (minimum or deployed) length to a second (actual shipping configuration) length, and potentially to a third (maximum) length, if different from the second length. In an implementation with multiple angle and height adjustable shipping protrusions, a first angle and height adjustable shipping protrusion may have different first, second, and third lengths than a second angle and height adjustable shipping protrusion. The shipping protrusion may be included for the modular tail section, the modular center section (as shown), and the modular nose section, and they may consist of crates or wheeled assemblies, enabling easy movement, alignment and connection of different modular sections on the ground.

FIG. 3F shows a compact nose gear configuration, which includes a rotating landing skid, a landing skid pivot, and landing skid shock absorber. These elements allow the skid to fly aligned with the airflow when in cruise, while enabling the skid to adjust to ground and keep the angled fuselage at the appropriate angled when the angled fuselage is landed (see FIG. 3G). The landing skid pivot location may be at the front, back, or middle of the compact nose gear. The landing skid shock absorber may include springs, dampers, flexible or sliding elements.

The angled fuselage enables several benefits. The first is that the height of the compact nose gear can be reduced, because the nose of the fuselage is lower when landed than it would be if the fuselage were level or near level, as in a conventional aircraft. This reduced height reduces the cost and mass of the compact nose gear. It also reduces the adverse aerodynamic effects of the compact nose gear during all phases of flight, from VTOL to transition to cruise, due to reduced drag and reduced crosswind effects. The other area of benefit of the angled fuselage is that it enables angled unified stabilizers and landing gear, which can combine both stabilization functions and landing functions into the same components. Combining these functions reduces cost, mass, and drag on the aircraft. The angled fuselage and the angled unified stabilizers and landing gear also enable easy access to the streamlined removable cargo pod, both from the side of the aircraft and from the rear.

Advantageously, in a specific implementation, the angled unified stabilizers and landing gear serve the function of a vertical stabilizer, both providing stability during flight and supporting the aircraft on the ground. Instead or in addition, the angled unified stabilizers and landing gear serve the function of a horizontal stabilizer and/or angular stabilizer during flight and/or on the ground.

The teachings of FIGS. 1A-4 can be combined to yield a modular rotating monowing architecture with streamlined removable cargo pod. It is not believed a separate figure is necessary for an understanding of how the teachings are combined.

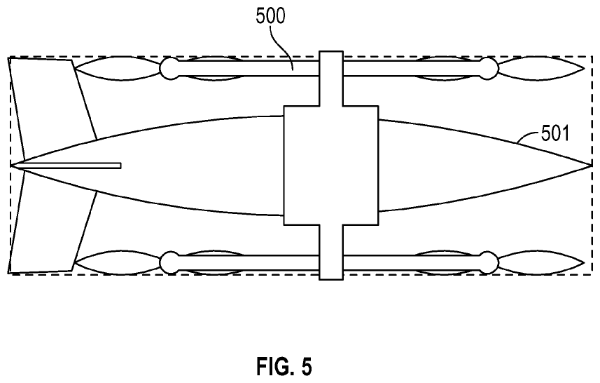

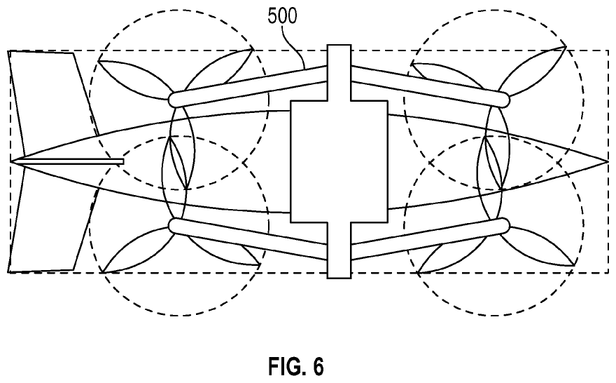

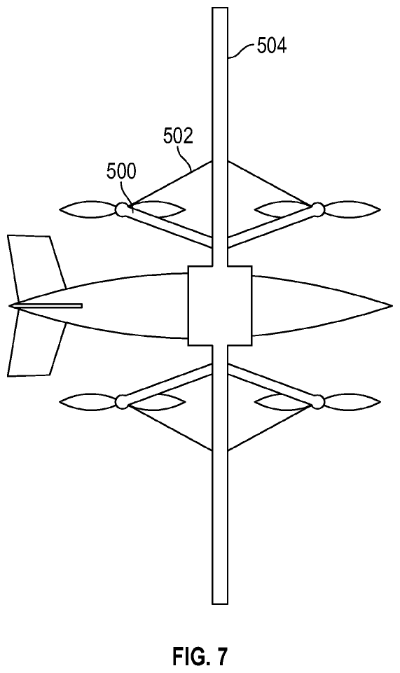

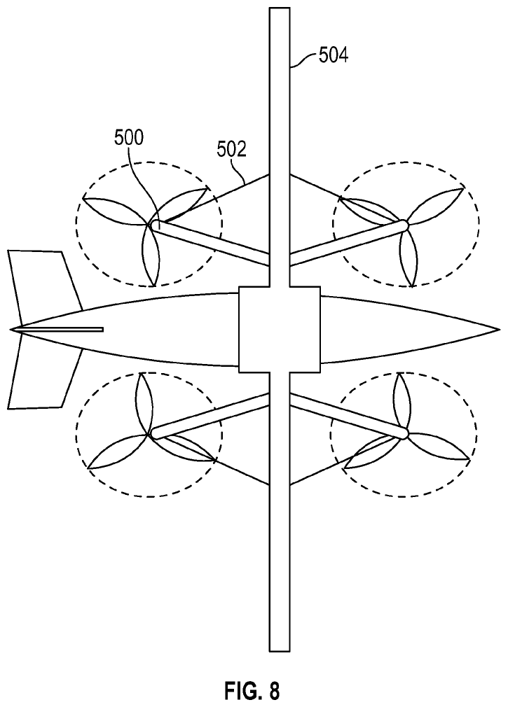

FIGS. 5-8 depict an example of an aircraft for which the fuselage, center wing section, propellers, and motors are packaged into a single shipping container. Components illustrated in the example of FIGS. 5-8 include moveable pylons 500, angled or straight fuselage 501, post-assembly pylon and wing securement 502, and a removable wing portion 504. Moveable pylons pivot to allow the propellers and pylons to fit in the container. The movable pylons can be tilted outward and secured in a deployed configuration using bolts, clips, clamps, hinges, or other suitable means. Removeable wing portions, also shipped within the same container, can be attached to the ends of the central wing section.

The pylons can be further secured to the wings using pylon and wing securements, which may be composed of flexible or rigid structural elements. These additional structural components not only secure the pylons in place, but also provide support for the removable wings. The pylon and wing securements can enable a significant reduction in both pylon and wing structure weight, helping to achieve a lighter overall aircraft.

The teachings of FIGS. 1A-4 and 5-8 can be combined to yield a modular rotating monowing architecture with streamlined removable cargo pod with removable pylons and associated components. It is not believed a separate figure is necessary for an understanding of how the teachings are combined.

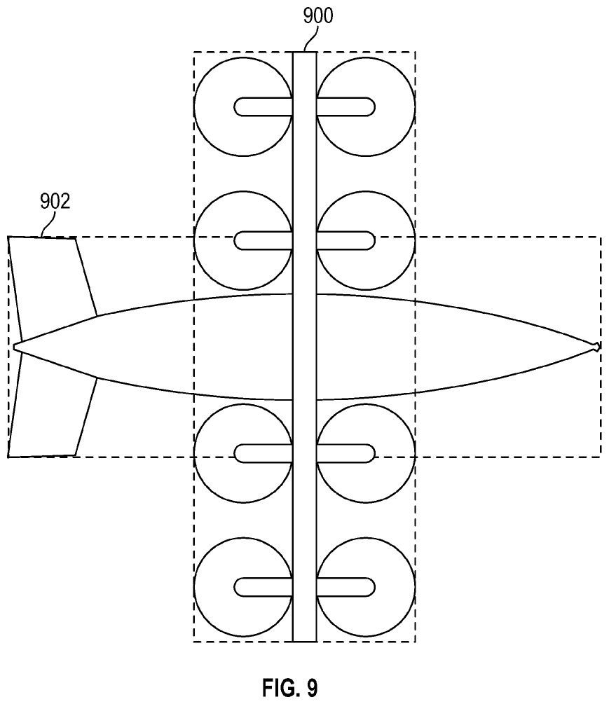

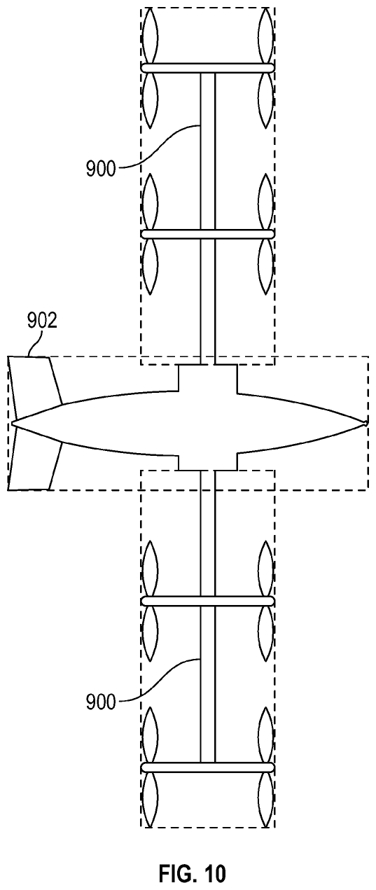

FIGS. 9 and 10 depict an example of a modular aircraft system comprising an angled or straight fuselage designed to receive separate wing, propeller, and motor combinations; separate wing, propeller, and motor combinations that can be shipped individually and assembled on-site, allowing for longer wingspans in constrained spaces such as shipping containers. Components illustrated in the example of FIGS. 9 and 10 include a removable monowing section 500 and a shipping optimized fuselage 502.

The teachings of FIGS. 1A-4, 5-8, and 9-10 can be combined to yield a configurable modular rotating monowing architecture with streamlined removable cargo pod with removable pylons and associated components. It is not believed a separate figure is necessary for an understanding of how the teachings are combined.

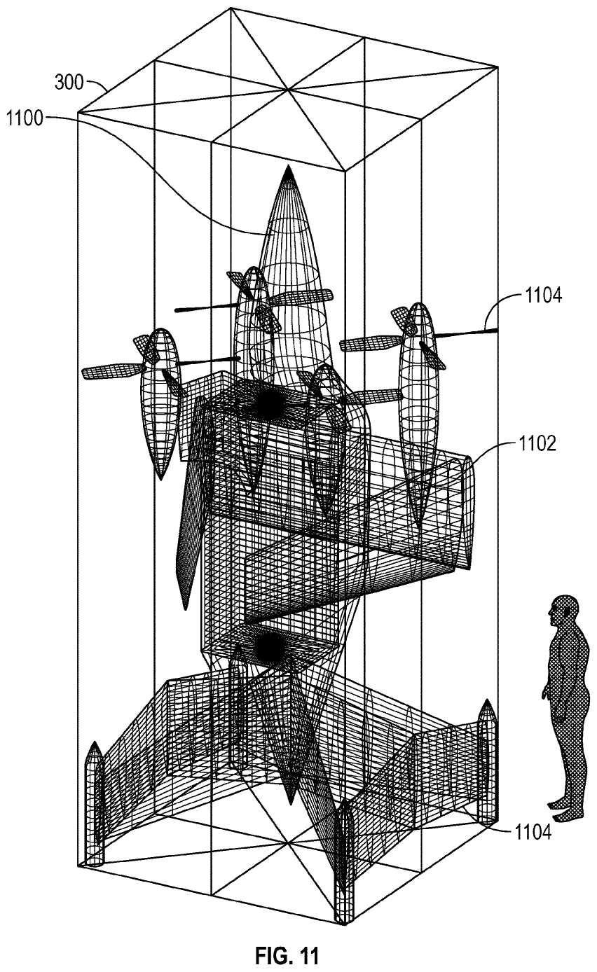

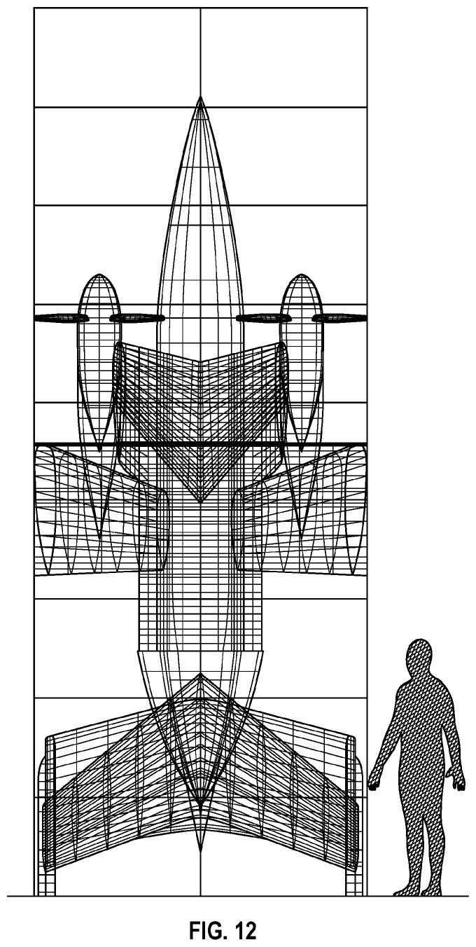

FIGS. 11-13 depict an example of an aircraft architecture comprising: a shipping optimized tail-sitter aircraft 1100; an aircraft capable of rotating into a flying orientation, transitioning into a hover and landing configuration using (activated) wing portions 1102; vertical unified stabilizers and landing gear 1104; and shipping optimized lifting and cruise propulsors. It may include one or more removable wing portions or removable monowing sections.

Tail-sitters have a high drag area when they get sideways. By rotating fuselage sideways, as you start flying sideways, it rotates into the wind. FIGS. 4-9 illustrate a teardrop shape that would move in the way it “wants” to go in such a scenario. So a biggest wall of drag rotates into the wind. The fuselage itself has low aspect ratio, helping to lift the craft. High aspect ratio wings perform better at high speed (e.g., 20′×1′) and specific speed points. Low aspect ratio wings are draggier (e.g., 20′×4′) but can work at a much lower speed. Counterintuitively, given most airlines don't care about low speed, low aspect ratio wings (e.g., between 20′×3′ and 20′×5′, inclusive) are advantageous because they help the props lift the vehicle. After 100 miles per hour, the fuselage doesn't need to act as a lifting component. In cruise mode, angle of attack is reduced (minimum drag) and you use the wings for lift, instead of using the fuselage for lift in transition. How much angle of attack (pivot) we can give people is typically limited by psychological factors (you don't want it to be scary). On inbound transition, when you stop getting lift from wings (stall), you want to get it to VTOL as quickly as possible. If in a helicopter, you would be propelled face first, but the illustrated architectures enable apparent deceleration toward floor.

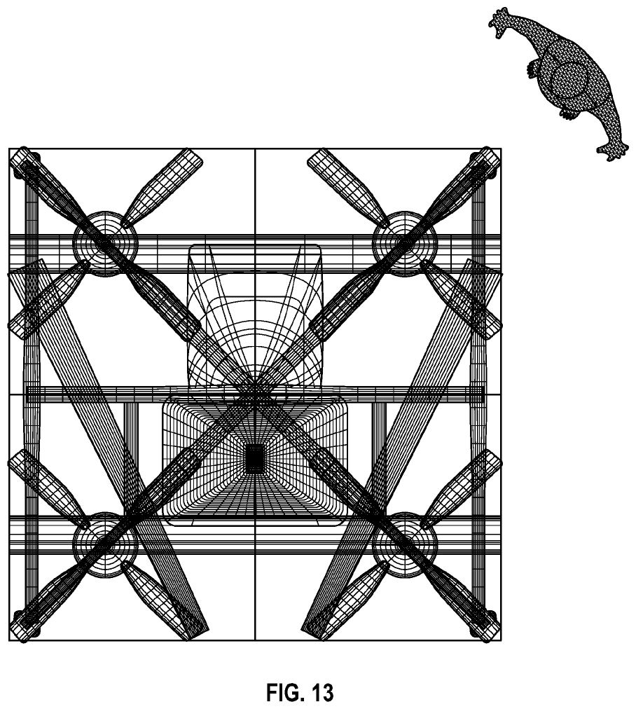

FIG. 13 shows shipping optimized lifting and cruise propulsors. In a specific implementation, these include movable propellers that can be positioned to minimize the shipping area while maintaining the largest swept propeller area during flight. In alternatives, the shipping optimized lifting and cruise propulsors include ducted fans or other propulsion devices.

The aircraft can include horizontal, angled, and/or vertical stabilizers incorporated as components in the landing mechanism to ensure ground stability and shock absorbers integrated into the landing gear for enhanced impact mitigation.

The teachings of FIGS. 1A-10 can be combined with the teachings of FIGS. 11-13 to the extent they are applicable in a tail-sitter configuration. It is not believed a separate figure is necessary for an understanding of how the teachings are combined.

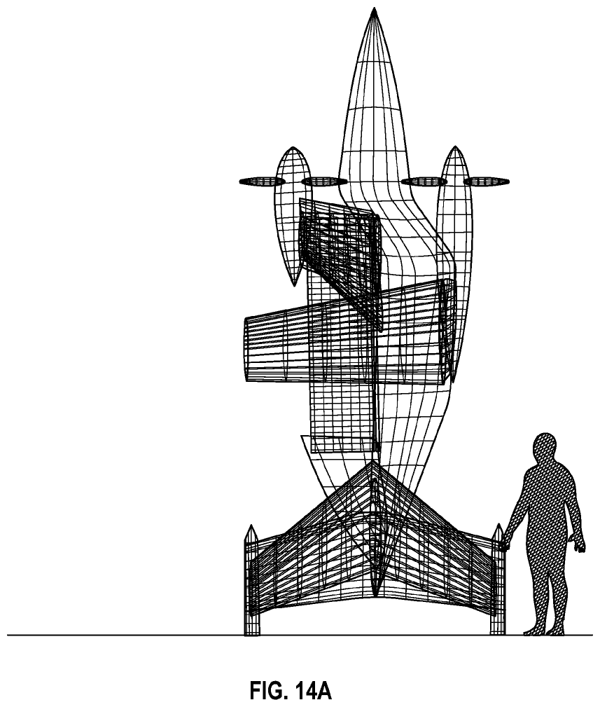

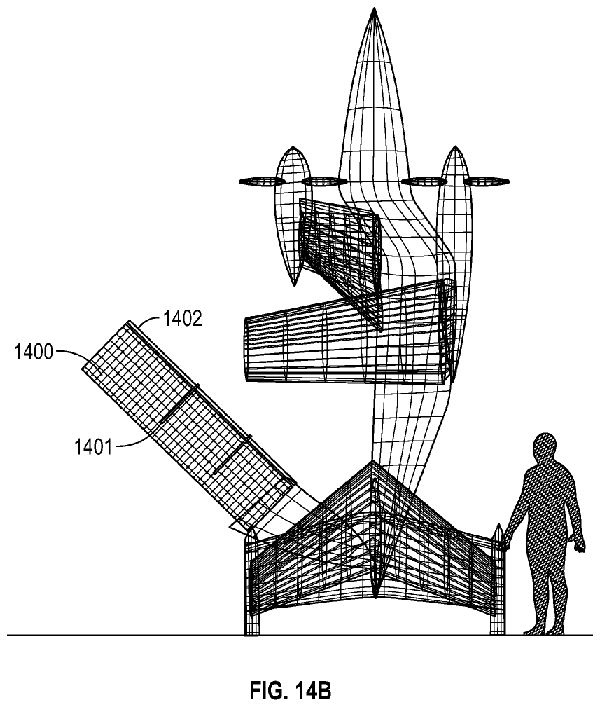

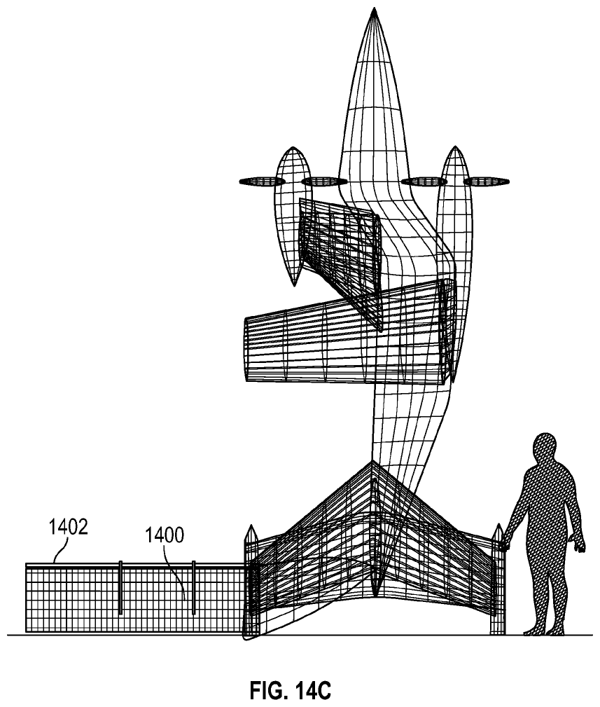

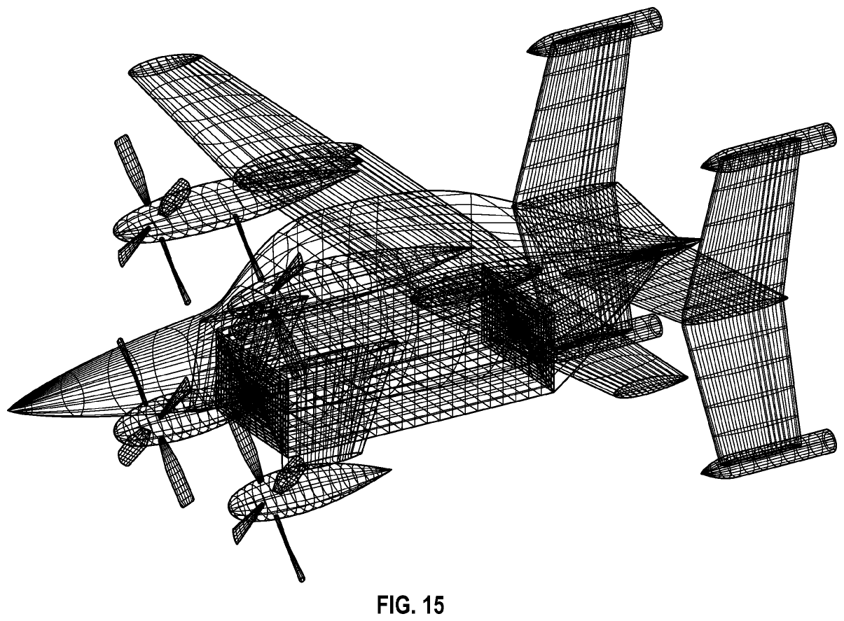

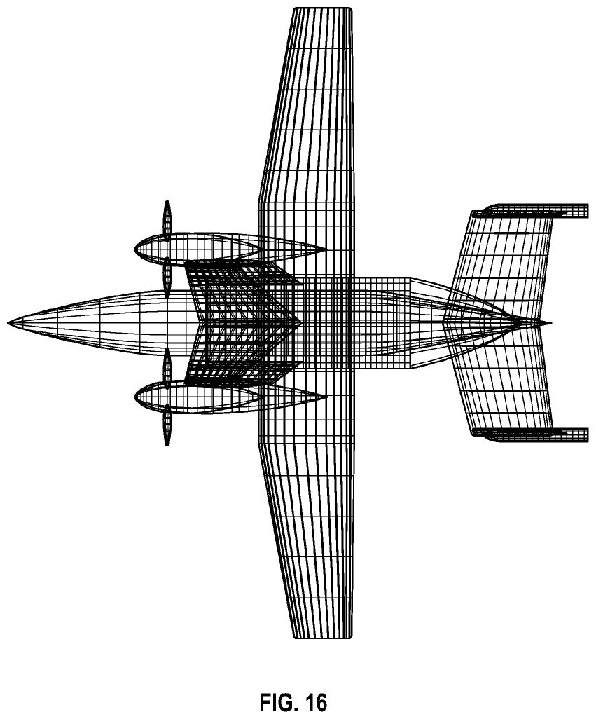

FIGS. 14A-16 depict an example of an example of a shipping optimized tail-sitter, including a variable orientation cargo pod 1400, anti-shifting features for the cargo pod 1401, a hinged lifting arm 1402, and the shipping optimized tail-sitter aircraft 1404. An expanding and folding wing system for the aircraft includes activated wing portions that can be closed for shipping and opened for forward flight; activated wing portions capable of being folded during takeoff, landing, and hover, and reducing aircraft footprint while maintaining stability by reducing exposure to crosswinds.

In a specific implementation, activated wing folding mechanisms include springs or pressure systems to facilitate wing folding when not subject to aerodynamic forces, designed so that aerodynamic forces in forward flight or hover exert folding or opening pressure on the wings. It may include brakes, hydraulic assemblies, air pressure systems, or other mechanisms to allow wing movement in accordance with above mechanisms and aircraft control system commands, enhancing reliability versus conventional direct actuated systems.

Another example of the shipping optimized tail-sitter architecture has removable wings, allowing for convenient detachment and attachment of wings as needed.

FIGS. 14A-14C depict a cargo lifting system for a shipping optimized tail-sitter aircraft, comprising: a hinged lifting arm attached to the aircraft and variable orientation cargo pod, configured to lift and position the variable orientation cargo pod near the center of gravity of the aircraft; actuation means such as cables, hydraulics, or linear actuators to control the hinged lifting arm. The variable orientation cargo pod may include anti-shifting features such as dividers, anchors, or straps to avoid cargo repositioning during orientation changes. The hinged lifting arm may be on top, below, or otherwise attached to the variable orientation cargo pod.

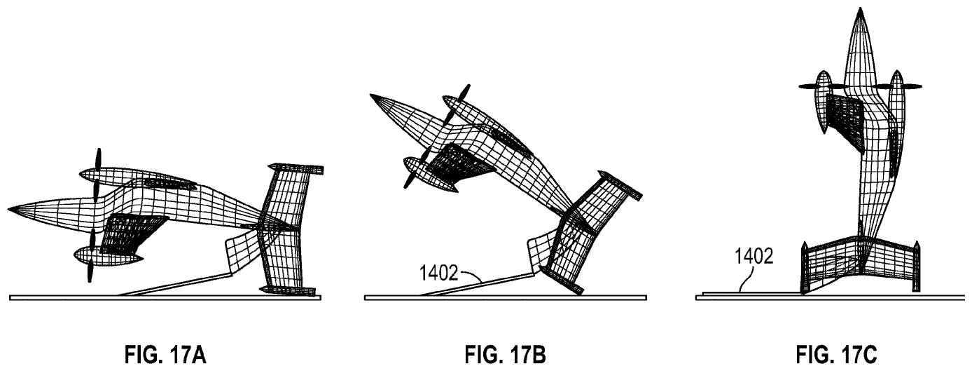

FIGS. 17A-17C depict a hinged lifting arm serving to raise the aircraft from horizontal to vertical positions, or to support the aircraft during the transition from vertical to horizontal positions, facilitating shipping, storage, or high-wind scenarios.

What is claimed is:

1. A system comprising:
a removable cargo pod;
an aircraft configured to receive the removable cargo pod;
a hinged lifting arm configured to lift and position the removable cargo pod near a center of gravity of the aircraft;
a height adjustable shipping protrusion attached to the aircraft for deployment when the aircraft is in shipping configuration;
wherein the aircraft has a shipping container outline, including the height adjustable shipping protrusion, with a first dimension of the shipping container outline no greater than a first dimension of a shipping container, a second dimension of the shipping container outline no greater than a second dimension of the shipping container, and a third dimension of the shipping container outline no greater than a third dimension of the shipping container.

2. The system of claim 1 comprising a rotating monowing.

3. The system of claim 1 comprising lift and cruise propulsors.

4. The system of claim 1 wherein the removable cargo pod is a streamlined removable cargo pod.

5. The system of claim 1 wherein the removable cargo pod is a variable orientation removable cargo pod.

6. The system of claim 1 comprising an angled fuselage.

7. The system of claim 1 comprising angled unified stabilizers and landing gear.

8. The system of claim 1 comprising compact nose gear.

9. The system of claim 1 wherein the aircraft is configured for Vertical Takeoff and Landing (VTOL).

10. The system of claim 1 comprising a modular tail section.

11. The system of claim 1 comprising a modular center section.

12. The system of claim 1 comprising a modular nose section.

13. The system of claim 1 wherein the height adjustable shipping protrusion is a height and angle adjustable shipping protrusion.

14. The system of claim 1 comprising an anti-shifting feature for deployment when the aircraft is in shipping configuration.

15. The system of claim 1 comprising a rotating landing skid.

16. The system of claim 1 comprising a landing skid shock absorber.

17. The system of claim 1 comprising a moveable pylon.

18. The system of claim 1 comprising post-assembly pylon and wing securement.

19. The system of claim 1 comprising a removable wing portion.

20. The system of claim 1 wherein the aircraft has a tail-sitter configuration.
